(19) United States
(12) Patent Application Publication
(10) Pub. No.: US 2016/0140056 A1
(43) Pub. Date: May 19, 2016

(54) METHODS TO IMPROVE SECURE FLASH PROGRAMMING

(71) Applicant: GM GLOBAL TECHNOLOGY OPERATIONS LLC, Detroit, MI (US)

(72) Inventors: ANSAF I. ALRABADY, LIVONIA, MI (US); DAVID J. ROSA, CLARKSTON, MI (US)

(73) Assignee: GM GLOBAL TECHNOLOGY OPERATIONS LLC, Detroit, MI (US)

(21) Appl. No.: 15/000,785

(22) Filed: Jan. 19, 2016

Related U.S. Application Data
(62) Division of application No. 13/904,715, filed on May 29, 2013, now Pat. No. 9,270,468.

(51) Int. Cl. G06F 12/14; H04L 9/32

(52) U.S. Cl. CPC G06F 12/1408; H04L 9/3247; H04L 9/3263; G06F 2212/1052; H04L 2209/24; H04L 2209/64; H04L 2209/72

(57) ABSTRACT

Methods are provided for securely loading software objects into an electronic control unit. The methods include receiving a first software object comprising a second level public key certificate, a first encryption signature and a first set of software. Once the first software object is received, validating the first second level public key is validated with the embedded root public key, the first encryption signature with the first second level public key certificate, and the first set of software with the first encryption signature. When the first set of software is valid, then the first second level public key certificate and the first set of software are stored to non-volatile memory. Once stored, a consecutive software object is received comprising only a consecutive encryption signature and a consecutive set of software from the programming source. The consecutive encryption signature is validated with the stored second level public key certificate, and the consecutive set of software is validated with the consecutive encryption signature.

### CROSS-REFERENCE TO RELATED APPLICATIONS

This is a continuation of, and claims priority from, U.S. application Ser. No. 13/904,715, filed on May 29, 2013, the entirety of which is hereby incorporated by reference herein.

### TECHNICAL FIELD

The technical field generally relates to the secure programming of a computing device. Specifically, methods are provided to reduce the bandwidth requirements required to load certificate secured software programming.

### BACKGROUND

The use of digital signature encryption methods is common when computing devices are programmed for the first time or reprogrammed later. A digital signature is a mathematical construct for demonstrating the authenticity of a digital message or document and gives a recipient reason to believe that the message was created by a known sender, and that the message was not altered in transit. Digital signatures are commonly used for software distribution, financial transactions, and in other cases where it is important to detect forgery or tampering.

Digital signatures employ a type of asymmetric cryptography and are equivalent to traditional handwritten signatures in many respects. However, properly implemented digital signatures are more difficult to forge than the handwritten type. Digitally signed messages may be anything representable as a bitstring such as electronic mail, computer programs, certificates, data, contracts, or a message sent via some other cryptographic protocol.

In brief, a computing device to be loaded with software typically includes a root public key that is previously installed or embedded in its memory. Any new software to be loaded has a certificate embedded therein that has been signed by a corresponding root private key, or a derivative thereof, residing at a trusted entity. Herein, the derivative of the root (public, private) key is a subordinate public key.

The subordinate private key, also known as a second level private key, is used when the access to the root private key is to be minimized. The subordinate public key, also known as a second level public key, is contained in a certificate signed by the root private key and the certificate itself is delivered with the file content. The second level private key is then used to sign the file content being transferred and uploaded to the computing device.

When uploading new software files into a computing device, the embedded root public key is used to validate (or certify) that the digital certificate traveling with the software file(s) is genuine. The new software file(s) are commonly created at a remote programming tool or other type of programming apparatus. Programming tools are well known in the art and will not be discussed herein in the interest of simplicity and brevity.

The software is uploaded into the computing device using a boot loader which is an elementary software object that usually exists in the operating system kernel that performs the task of uploading and installing software into memory of the computing device. Boot loaders are well known in the art and details thereof will not be discussed in further detail in the interest of simplicity and brevity.

Once the digitally certificated file(s) are received at the computing device, the digital certificate containing the second level public key is validated by the embedded root public key. Certificate signature validation is well known in the art and details thereof will not be discussed in further detail in the interest of simplicity and brevity and will be referred to herein as “validation.”

Once the digital certificate is validated, the second level public key in the digital certificate is then in turn used to validate the digital signature on the associated application software or data file. Hereinafter, the application software, data file, calibration packages, data package or “data” for system operation to be loaded into the ECU may also be referred to as the “soft part” of the file structure being loaded. The “soft part” does not refer to certificates, keys or other digital objects used for security purposes.

Conventionally, should multiple software applications, calibration packages or data files need to be loaded, the same certificate is usually attached to every data file in the soft part and transmitted repeatedly from the programming tool to the processor of the computing device. Such retransmission of the second level key certificate for every data file in the soft part requires consumption of excessive bandwidth on an already limited capacity data bus and requires unnecessary processing time for the actual re-validation by the processor. Thus, it is desirable to develop innovative methods of programming a computing device to minimize bandwidth and processor overhead used to validate a software upload.

Further, other desirable features and characteristics of the present invention will become apparent from the subsequent detailed description and the appended claims, taken in conjunction with the accompanying drawings and the foregoing technical field and background.

### SUMMARY

A method for loading multiple software objects into a computing device containing a root public key is provided. The method comprises receiving a first software object from a programming source, the first software object further comprising a second level public key certificate, a first encryption signature and a first set of data and validating the first set of data. When the first set of data is valid, the second level public key certificate is stored in a memory of the computing device and the first set of data is written into the memory of the computing device. The method further comprises receiving a second software object from the programming source, the second software object comprising a second encryption signature, a second set of data from the programming source but lacking the second level public key certificate. Still further, the method comprises validating the second encryption signature with the stored second level public key certificate and validating the second software object with the second encryption signature and writing the second set of data to the memory of the computing device.

A program product for loading multiple software objects into a computing device containing a root public key is provided. The program comprises a program and a non-transitory, computer-readable storage medium. The program is configured to at least facilitate receiving a first software object from a programming source, the first software object comprising a second level public key certificate, a first encryption signature and a first set of data, validating the first set of data, when the first set of data is valid, then storing the second level public key certificate in a memory of the computing device and writing the first set of data to a memory of the computing device, receiving a second software object from the programming source, the second software object comprising a second encryption signature, a second set of data from the programming source and lacking the second level public key certificate, validating the second encryption signature with the stored second level public key certificate of the first software object, validating the second software object with the second encryption signature, and writing the second set of data to the memory of the computing device. The non-transitory, computer-readable storage medium is configured to store the program.

A computing device is provided. The computing device comprises a memory and a processor. The processor is configured to at least facilitate receiving a first software object from a programming source, the first software object comprising a second level public key certificate, a first encryption signature, and a first set of data, validating the first set of data, when the first set of data is valid, then storing the second level public key certificate in the memory and writing the first set of data to the memory, receiving a second software object from the programming source, the second software object comprising a second encryption signature, a second set of data from the programming source and lacking the second level public key certificate, validating the second encryption signature with the stored second level public key certificate of the first software object, validating the second software object with the second encryption signature, and writing the second set of data to the memory.

### DESCRIPTION OF THE DRAWINGS

The exemplary embodiments will hereinafter be described in conjunction with the following drawing figures, wherein like numerals denote like elements, and wherein:

FIG. 1 is an exemplary block diagram of a vehicle configured to load software into an electronic control unit (ECU);

FIG. 2 are exemplary depictions of the structure of a conventional application file and a calibration data file;

FIG. 3 are exemplary depictions of the structure of an conventional application file and an calibration data file according to embodiments described herein;

FIG. 4 is a logic diagram for loading multiple data files that are associated with the same second level public key certificate;

FIG. 5 is a logic diagram for loading multiple data files that are associated with at least one different second level public key certificate.

### DETAILED DESCRIPTION

The various illustrative components and logical blocks described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The word “exemplary” is used exclusively herein to mean “serving as an example, instance, or illustration.” Any embodiment described herein as “exemplary” is not necessarily to be construed as preferred or advantageous over other embodiments.

The steps of a method or algorithm described in connection with the embodiments disclosed herein may be embodied directly in hardware, in a software module executed by a processor, or in a combination of the two. Software may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Further, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

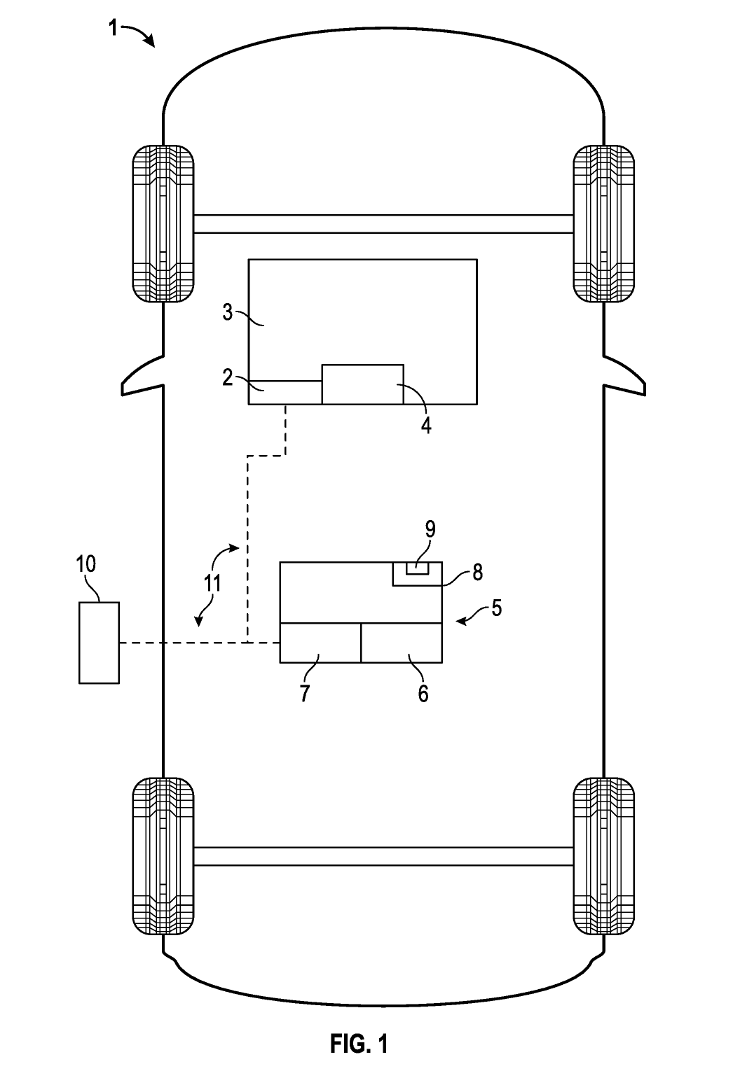

FIG. 1 is a simplified functional block diagram of a vehicle 1 incorporating a common boot loader 8 according to various embodiments. The vehicle 1 may be any vehicle incorporating one of more electronically controlled devices 3 that are controlled by a computing device or an electronic control unit (ECU) 5. Although depicted as an automotive ground vehicle, the description herein is not intended to be so limiting. A vehicle may also include aircraft and watercraft, and other land vehicles of all types currently known or developed in the future. The ECU may be any type of computing device configured for any use.

The electronically controlled device 3 may have a power supply 4 (e.g., a battery) and a sensor package 2 comprising any number or type of sensors as may be determined to be useful for a particular situation. Output signals from the sensor package 2 may be transmitted to the ECU 5 via a data bus 11.

The ECU 5 comprises at least a boot loader 8 configured to load content or the “soft part” of a file (e.g., application software, calibration data, data files, etc.) into the ECU 5 from a programming tool 10, which is depicted as being located outside the vehicle. However, the location of the programming tool 10 is not intended to be limited to an external location. The programming tool 10 may be located inside the vehicle 1 as well. In preferred embodiments, the ECU 5 is a secure computing device as may be known to those or ordinary skill in the art or that may be devised in the future.

The ECU 5 includes a processor 7 and at least one volatile or non-volatile memory device(s) 6. The non-volatile memory device 6 may be any non-volatile memory storage device known in the art. Non-limiting example of non-volatile memory devices includes read only memory, flash memory, electronically erasable read only memory (EEPROM) and the like that may currently exist or exist in the future.

The boot loader 8 is a software object that is written and embedded in the operating device that loads other content, such as the operating system kernel, application software and calibration data into memory. In preferred embodiments, the boot loader 8 has access to secure storage, where embedded encryption codes, keys and certificates, such as root public key 9, may reside. Such encryption codes, keys and certificates may also be stored in unsecured memory. However, such unsecured storage could adversely affect the security methods and systems being disclosed herein below.

Although the subject matter disclosed herein is compatible with other types of encryption/authentication techniques (e.g., symmetric digital key validation), the following disclosure of various embodiments will be discussed in the framework of asymmetric digital key validation for ease of discussion and simplicity.

In brief, a digital signature scheme typically consists of three algorithms:
1) A key generation algorithm that selects a private key and outputs the private key and a corresponding public key (here the root public key and the root private key).
2) A signing algorithm that, given a message and a private key, produces a signature.
3) A signature verifying algorithm that, given a message, public key and a signature, either accepts or rejects the message's claim to authenticity.

Two main properties of the algorithms are required. First, a signature generated from a fixed message (such as a hash of the message) and fixed private key should verify the authenticity of that message by using the corresponding public key. Secondly, it should be computationally infeasible to generate a valid signature for a party who does not possess the private key.

A typical asymmetric digital key validation uses two different but mathematically related keys to sign, and then validate, a digital certificate: a private key and a public key. The private key is known only to a sending unit while the root public key 9 is given to any receiving computer such as ECU 5.

Typically, a file is validated by decrypting the embedded signature with a corresponding public key that is associated with the content of the file. A hash is then taken of the content of the file. If the hash matches the decrypted signature then the file is validated. This means of decryption is merely exemplary. Other equivalent decryption methods and variations may exist and be used without departing from the scope of the inventive subject matter herein. This and other validation methods are well known in the art and will not be described further herein in the interest of clarity and brevity. The term “validation” used herein after refers to any suitable validation algorithm used in the art that may be found to be useful to meet a design requirement.

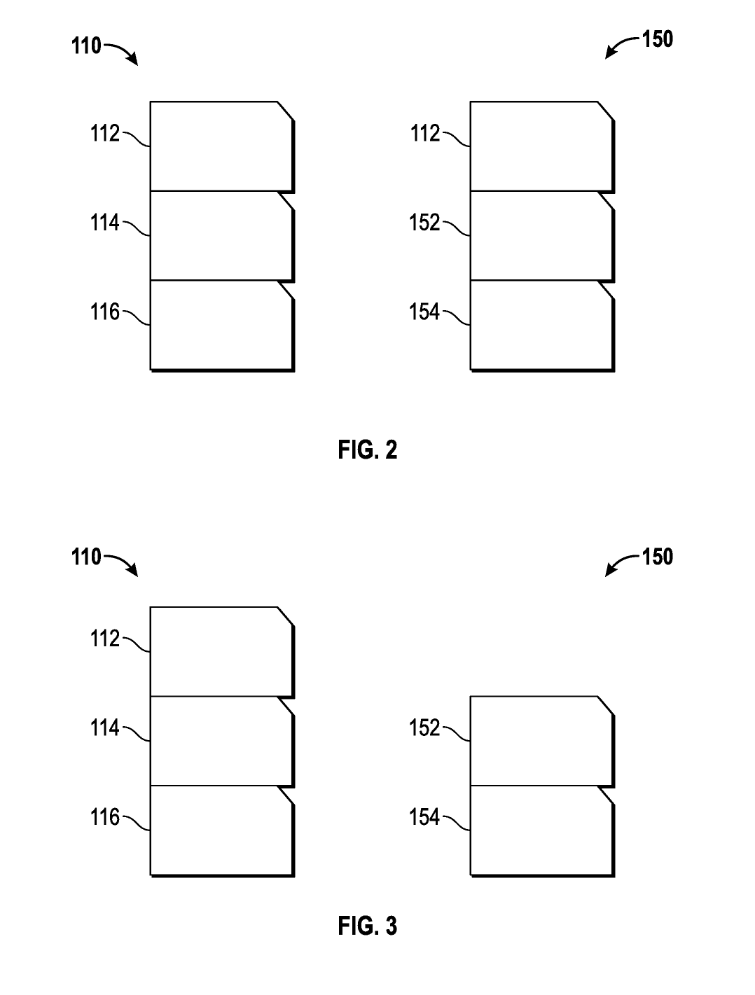

FIG. 2 is a simplified rendition of an exemplary set of data files that may be conventionally loaded into ECU 5 by programming tool 10 via boot loader 8. In this rendition an application software file 110 and a calibration data file 150 are depicted, although their order in the drawing is merely exemplary and is not meant to be limiting. The exemplary application software file 110 includes application software 116, an encryption signature 114, and a second level public key certificate 112. The second level public key certificate 112 is signed by the root private key (not shown). The exemplary calibration data file 150 also comprises the second level public key certificate 112, an encryption signature 152 and the calibration data 154 itself. The encryption signatures 114 and 152 contain the digital signature for the respective data files.

FIG. 3 is a simplified rendition of one exemplary set of required data files according to novel embodiments described herein below that may be loaded into ECU 5 by programming tool 10. In this rendition an application software file 110 and a calibration data file 150 according to embodiments herein are represented, although their order in the drawing is merely exemplary and not meant to be limiting. The exemplary application software file 110 includes the application software 116, an encryption signature 114 and a second level public key certificate 112. The exemplary calibration data file 150 comprises only the encryption signature 152 and the calibration data 154 itself. In embodiments disclosed herein, there is no need for the second level public key certificate 112 to be included.

An advantage of the methods described herein below is to reduce the bandwidth requirements on the data bus 11 when loading software by dispensing with the need to transmit the second level public key certificate 112 with each consecutive file that is being loaded after the first file that includes the second level public key certificate. For example, if the loading of an application software file 110 requires the subsequent or consecutive loading of 21 calibration data files 150, then conventionally the second level public key certificate 112 was transmitted 22 times, once with each file.

However, the required amount of computing resources may be reduced, by storing the validated second level public key certificate 112 into memory 6, or even into volatile memory such as random access memory. Thus, multiple consecutive files may be loaded into ECU 5 more efficiently by not having to transmit the second level public key certificate 112 for every file. The second level public key certificate 112 may be attached to any of the software objects being uploaded. However, the second level public key certificate 112 need only be attached to a software object (e.g., 112, 114, 116, 152, 154) when the second level public key certificate 112 is different from a previous version.

In addition to the exemplary methods disclosed herein, there is a plethora of similar, alternative variations of the following exemplary methods depending on where the second level public key certificate(s) are residing in the various files uploaded or how the certificate is stored in memory. These variations would be readily apparent to those of ordinary skill in the art after having read Applicant's specification. For example, the second level public key certificate 112 may be located in the actual application software 116 or within the calibration data 154.

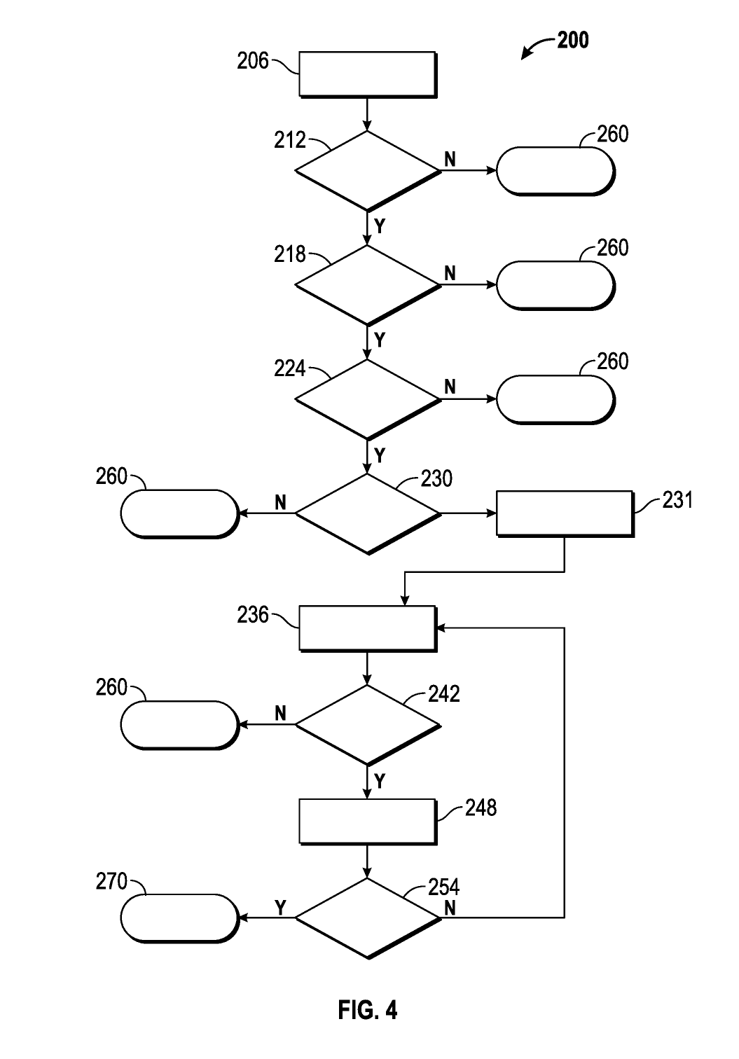

FIG. 4 is an exemplary logic flow diagram of a method 200 that may be used to efficiently load multiple files assuming only one second level public key certificate 112 is used for all files. The method 200 also allows a special purpose key replacement file package to be dispensed with. It should be noted that processes illustrated may be broken down into sub-processes and sub-processes combined together without departing from the scope of this disclosure. Further, processes may be rearranged in order to produce alternative but functionally equivalent embodiments.

In this example the application software 116 and one or more calibration data files 154 are being loaded. The method begins when the boot loader 8 receives an application software file 110 file from the programming tool 10 at process 206. At process 212, the boot loader 8 validates the second level public key certificate 112 of the application software file 110 using the root public key 9 that was embedded in ECU memory 6 at manufacture. If not valid then the process produces an error at process 260. Once validated by the root public key 9, the second level public key certificate 112 is used to then validate the digital signature in the encryption signature 114 of the application software 116 at process 218.

Once the encryption signature 114 is validated at process 224, the application software 116 is in turn validated based in part on the digital signature from the encryption signature 114 at process 230. The application software 116 is written to memory 6. In addition, at process 230, the validated second level public key certificate 112 is also stored to memory 6 for subsequent use at process 242. The writing of the application software file 110 to memory 6 is completed at process 231.

In equivalent alternative embodiments, the application software 116 may be written to flash memory 6 first at process 230 and then subsequently validated by the boot loader 8 at process 224. In this case the boot loader 8 would enable the application software 116 only after only after it was validated. This embodiment may be useful where an ECU memory buffer (not shown) is too small to hold the entire application software 116. Hence, the larger main nonvolatile memory 6 may be used as an alternative buffer to the boot loader 8.

At process 236, the boot loader 8 receives the next file, which in this example is a calibration data file 150. At process 242, the encryption signature(s) 152 of any consecutive file(s) are validated using the second level public key certificate 112 that was stored in memory 6 at process 231 in the same or equivalent manner as used at process 212. The calibration data 154 is written to memory 6 at process 248 and validated by the validated encryption signature 152 at process 254.

As discussed above, in equivalent embodiments the calibration data 154 may be written to flash memory first at process 248 and then subsequently validated by the boot loader 8 at process 231. In this case the boot loader 8 would enable the calibration data 154 only after only after it was validated. This embodiment may be useful where an ECU memory buffer (not shown) is too small to hold the entire calibration data 154. Hence, the larger main nonvolatile memory 6 may be used as an alternative buffer.

If the calibration data is the last data being transmitted from the programming tool 10 at decision point 254, then the method 200 ends at 270. Otherwise, the method 200 loops back to process 236 where the next file is received.

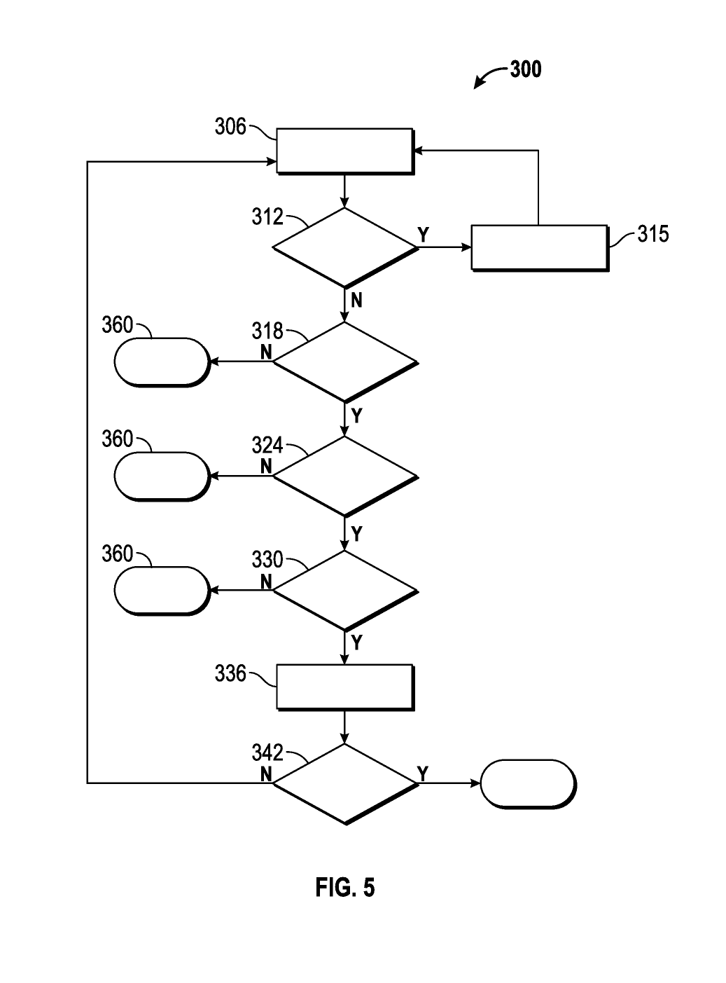

FIG. 5 is an exemplary logic flow diagram of a method 300 that may be used to efficiently load multiple files assuming different consecutive second level public key certificates 112 are used for some files. In this case, a different second level public key certificate is utilized with its associated software on a limited basis. In this example the application software 116 and one or more calibration data files 154 are being loaded. The method begins when the boot loader 8 receives a software object (e.g., a file 110/150) from the programming tool 10 at process 306.

At process 312, the boot loader 8 determines when the file received (110 or 150) is associated with a different second level public key certificate 112 than a second level public key certificate that has previously been stored in the ECU memory 6.

When the file received is associated with a second level public key certificate already stored in the ECU memory 6, the encryption signature 114 of the consecutive set of software (110/150) is validated with the stored second level public key certificate, which in turn is used to validate the consecutive set of software at process 315. The consecutive set of software is then written to the ECU memory 6.

When the file received is not associated with a second level public key certificate already stored in the ECU memory 6, the second level public key certificate 112 of the received file is validated by the embedded root public key 9 at process 318. If it can't be validated an error is generated at 360. In turn, the encryption signature 114 is validated using the validated second level public key certificate 112 at process 324.

At process 330, the second (or the consecutive) set of application software 116 is then validated with the associated validated encryption signature 114 and is written to memory 6 at process 336. As discussed above the memory 6 may also be used as an alternative memory buffer where the second set of software is stored to memory 6 at process 336 and subsequently validated at process 330.

If the second set of application software 116 is the last set of software to be loaded then the method ends 370. If not the method 300 loops back to process 306.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claim and the legal equivalents thereof.

What is claimed is:

1. A method for loading multiple software objects into a computing device containing a root public key, the method comprising:
receiving a first software object from a programming source, the first software object comprising a second level public key certificate, a first encryption signature and a first set of data;
validating the first set of data;
when the first set of data is valid, then storing the second level public key certificate in a memory of the computing device and writing the first set of data to a memory of the computing device;
receiving a second software object from the programming source, the second software object comprising a second encryption signature, a second set of data from the programming source and lacking the second level public key certificate;
validating the second encryption signature with the stored second level public key certificate of the first software object;
validating the second software object with the second encryption signature; and
writing the second set of data to the memory of the computing device.

2. The method of claim 1, further comprising validating the second level public key certificate with the root public key.

3. The method of claim 1, further comprising validating the first encryption signature using the validated first second level public key certificate.

4. The method of claim 1, wherein the first set of data is verified with the first encryption signature.

5. The method of claim 1, wherein the root public key is an asynchronous public root encryption key.

6. The method claim 1, wherein the computing device comprises an engine control unit for a vehicle, and the method is performed onboard the vehicle.

7. A program product for loading multiple software objects into a computing device containing a root public key, the program product comprising:
a program configured to at least facilitate:
receiving a first software object from a programming source, the first software object comprising a second level public key certificate, a first encryption signature and a first set of data;
validating the first set of data;
when the first set of data is valid, then storing the second level public key certificate in a memory of the computing device and writing the first set of data to a memory of the computing device;
receiving a second software object from the programming source, the second software object comprising a second encryption signature, a second set of data from the programming source and lacking the second level public key certificate;
validating the second encryption signature with the stored second level public key certificate of the first software object;
validating the second software object with the second encryption signature; and
writing the second set of data to the memory of the computing device; and
a non-transitory, computer-readable storage medium configured to store the program.

8. The program product of claim 7, wherein the program is further configured to at least facilitate validating the second level public key certificate with the root public key.

9. The program product of claim 7, wherein the program is further configured to at least facilitate validating the first encryption signature using the validated first second level public key certificate.

10. The program product of claim 7, wherein the program is further configured to at least facilitate verifying the first set of data with the first encryption signature.

11. The program product of claim 7, wherein the root public key is an asynchronous public root encryption key.

12. The program product of claim 7, wherein the computing device comprises an engine control unit for a vehicle, and the program is configured to be executed by the engine control unit onboard the vehicle.

13. A computing device comprising:
a memory; and
a processor configured to at least facilitate:
receiving a first software object from a programming source, the first software object comprising a second level public key certificate, a first encryption signature, and a first set of data;
validating the first set of data;
when the first set of data is valid, then storing the second level public key certificate in the memory and writing the first set of data to the memory;
receiving a second software object from the programming source, the second software object comprising a second encryption signature, a second set of data from the programming source and lacking the second level public key certificate;
validating the second encryption signature with the stored second level public key certificate of the first software object;
validating the second software object with the second encryption signature; and
writing the second set of data to the memory.

14. The computing device of claim 13, wherein the program is further configured to at least facilitate validating the second level public key certificate with a root public key of the computing device.

15. The computing device of claim 13, wherein the program is further configured to at least facilitate validating the first encryption signature using the validated first second level public key certificate.

16. The computing device of claim 13, wherein the program is further configured to at least facilitate verifying the first set of data with the first encryption signature.

17. The computing device of claim 14, wherein the root public key is an asynchronous public root encryption key.

18. The computing device of claim 13, wherein the computing device comprises an engine control unit for a vehicle.

19. The computing device of claim 18, wherein the engine control unit is disposed onboard the vehicle, and the programming source is disposed remote from the vehicle.

20. The computing device of claim 18, wherein the vehicle comprises an automotive vehicle.
